(19) United States
(12) Patent Application Publication
(10) Pub. No.: US 2026/0186288 A1
(43) Pub. Date: Jul. 2, 2026

(54) MICROSCOPE OBJECTIVE TURRET AND MICROSCOPE

(71) Applicant: AAC Microtech (Changzhou) Co., Ltd., Changzhou City (CN)

(72) Inventors: Chongdeng Wu, Changzhou (CN); Qihuan Zhu, Changzhou (CN); Rui Zhang, Changzhou (CN); Huifang Dong, Changzhou (CN); Xueyuan Zhu, Changzhou (CN)

(21) Appl. No.: 19/325,477

(22) Filed: Sep. 10, 2025

Related U.S. Application Data
(63) Continuation of application No. PCT/CN2024/143947, filed on Dec. 30, 2024.

(51) Int. Cl. G02B 21/24

(52) U.S. Cl. CPC G02B 21/248

(57) ABSTRACT

A microscope objective turret includes a base provided with a light-transmitting aperture, a turret rotatably connected to the base and provided with multiple objective mounting holes, with the light-transmitting aperture may be aligned with any one of the objective mounting holes, a rotating connection member fixedly connected to the turntable, a driving unit coaxially arranged with the rotating connection member and configured to drive the rotating connection member to rotate, a grating scale fixedly connected to the rotating connection member, and a grating scale reader fixedly connected to the base and arranged on the outer periphery of the grating scale. The driving unit drives the rotating connection member to rotate, thereby driving the grating scale to rotate, and the grating scale reader is configured to measure the rotational angle of the grating scale. The microscope objective turret achieves full closed-loop feedback of the position and higher positioning accuracy.

### CROSS-REFERENCE TO RELATED APPLICATIONS

This application is a continuation of International Application No. PCT/CN2024/143947, filed Dec. 30, 2024, the entire contents of which are incorporated herein by reference.

### TECHNICAL FIELD

The present application relates to the field of microscope technologies, in particular to a microscope objective turret and a microscope.

### BACKGROUND

A microscope is an optical instrument configured to observe microscopic objects. Through the optical design of the objective lens, it can converge the light from the observed sample to form a clear image. Whether observing the same sample or different samples, there may be varying requirements for magnification. Therefore, microscope objective turrets are implemented in relevant technologies. During observation, the turret can be rotated to select and replace objective lenses with different magnifications. However, in conventional objective lens turrets, the positioning unit employs a mechanical positioning method where a spring plate is embedded in a groove, which cannot achieve precise positioning.

Therefore, it is necessary to provide a new microscope objective turret.

### SUMMARY

An object of the present application is to provide a microscope objective turret that addresses the technical issue of the inability to achieve precise positioning in the related art.

The technical solution of the present application is as follows:

In the first aspect, provided is a microscope objective turret, including:
a base provided with a light-transmitting aperture;
a turntable rotatably connected to the base, and provided with a plurality of objective mounting holes, wherein the light-transmitting aperture is aligned with any one of the objective mounting holes;
a rotating connection member fixedly connected to the turntable;
a driving unit coaxially arranged with the rotating connection member and configured to drive the rotating connection member to rotate;
a grating scale fixedly connected to the rotating connection member; and
a grating scale reader fixedly connected to the base and disposed on an outer periphery of the grating scale;
wherein the driving unit drives the rotating connection member to rotate and thereby drives the grating scale to rotate, and the grating scale reader is configured to measure a rotational angle of the grating scale.

Furthermore, in some embodiments, the driving unit includes a magnet coaxially sleeved around the rotating connection member and fixedly connected to the rotating connection member, and a coil provided on an outer periphery of the magnet and fixedly assembled to the base, wherein the coil is configured to drive the magnet to rotate and thereby drive the rotating connection member to rotate.

Furthermore, in some embodiments, the base includes a main body connected to the turntable and a cover portion protruding from the main body away from the turntable; the light-transmitting aperture is arranged through the cover portion and the main body, and the main body further includes a connection hole arranged through the main body; the cover portion further includes a connection cavity communicating with the connection hole, wherein the connection hole and the connection cavity are both isolated from the light-transmitting aperture; at least a portion of the rotating connection member passes through the connection hole and extends into the connection cavity, and the grating scale and the grating scale reader are located within the connection cavity.

Furthermore, in some embodiments, an outer peripheral side of the base is provided with a first limiting groove with an opening facing the turntable, and an outer peripheral side of the turntable is provided with a second limiting groove with an opening facing the base; the first limiting groove and the second limiting groove are arranged oppositely and spaced apart to form a limiting space, and the microscope objective turret further includes a support member disposed within the limiting space.

Furthermore, in some embodiments, the turntable includes a mounting portion connected to the base and a connection groove extending from the mounting portion away from the base; the connection groove is in communication with the connection hole and has an opening facing the connection hole, an end of the rotating connection member close to the turntable is fixed within the connection groove, and the plurality of objective mounting holes are provided on the mounting portion and arranged around the connection groove; the microscope objective turret further includes a damping device located in the connection groove and sleeved around an outer periphery of the rotating connection member.

Furthermore, in some embodiments, the driving unit is disposed within the connection groove and located between the grating scale and the damping device.

Furthermore, in some embodiments, the microscope objective turret further includes a grating scale encoder disposed within the connection cavity and fixed to the base, wherein the grating scale encoder is configured to read the rotational angle of the grating scale and feed it back to an external controller.

Furthermore, in some embodiments, the microscope objective turret further includes a protrusion fixedly connected to a side of the base back away from the turntable, wherein the protrusion is provided with a mounting hole communicating with the light-transmitting aperture, and the protrusion is configured to connect to an external device.

Furthermore, in some embodiments, the grating scale and the rotating connection member are connected by screws, male-female connections, or welding.

Furthermore, in some embodiments, the turntable and the rotating connection member are connected by screws, male-female connections, or welding.

Furthermore, in some embodiments, the grating scale reader and the base are connected by screws, male-female connections, or welding.

The second aspect of the present application provides a microscope including a plurality of objectives and the aforementioned objective turret, wherein the plurality of objectives are removably connected to the plurality of objective mounting holes.

The beneficial effects of the present application are as follows: in the present application, the turntable can rotate relative to the base, enabling the light-transmitting aperture on the base to align with any one of the objective mounting holes on the turntable. Thus, when an objective lens is mounted in an objective mounting hole, a light path can be formed between the light-transmitting aperture and the objective lens to achieve the magnification function of the objective lens. Additionally, multiple objective mounting holes can accommodate different objective lenses, thereby meeting the requirements for different magnification effects. Furthermore, the driving unit can drive the rotating connection member to rotate, thereby driving the turntable to rotate through the rotating connection member, achieving automation. Furthermore, the grating scale and the rotating connection member are fixedly connected, so that synchronous rotation of the grating scale and the turntable can be achieved through the rotating connection member. A grating scale reader is fixedly connected to the base. Therefore, when the driving unit drives the grating scale and the turntable to rotate synchronously through the rotating connector, the grating scale reader can measure the rotational angle of the grating scale and the turntable, thereby enabling positioning of the objective mounting holes on the turntable, ultimately aligning the objective lens with the light-transmitting aperture. Compared to the mechanical positioning methods in the related art, the embodiments of the present application can achieve full closed-loop feedback of the position and has higher positioning accuracy.

### BRIEF DESCRIPTION OF THE DRAWINGS

FIG. 1 is a three-dimensional structural diagram of a microscope objective turret according to an embodiment of the present application.

FIG. 2 is a cross-sectional diagram of the microscope objective turret according to an embodiment of the present application taken along line A-A in FIG. 1.

FIG. 3 is a three-dimensional exploded view of the microscope objective turret according to an embodiment of the present application.

In the figures: 1, base; 11, light-transmitting aperture; 12, main body; 121, connection hole; 13, cover section; 131, connection cavity; 14, first limiting groove; 15, protrusion; 151, mounting hole; 2, turntable; 21, objective mounting hole; 22, mounting portion; 23, connection groove; 24, second limiting groove; 3, rotating connection member; 4, grating scale; 5, grating scale reader; 51, reader signal line; 6, grating scale encoder; 7, driving unit; 71, magnet; 72, coil; 73, power line; 8, damping device; and 9, support member.

### DETAILED DESCRIPTION OF THE EMBODIMENTS

The present application will be described in further detail with reference to the accompanying drawings and embodiments.

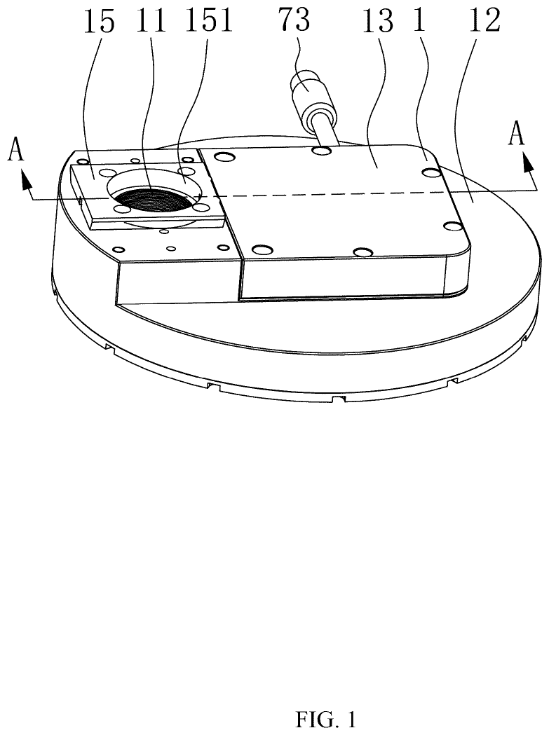

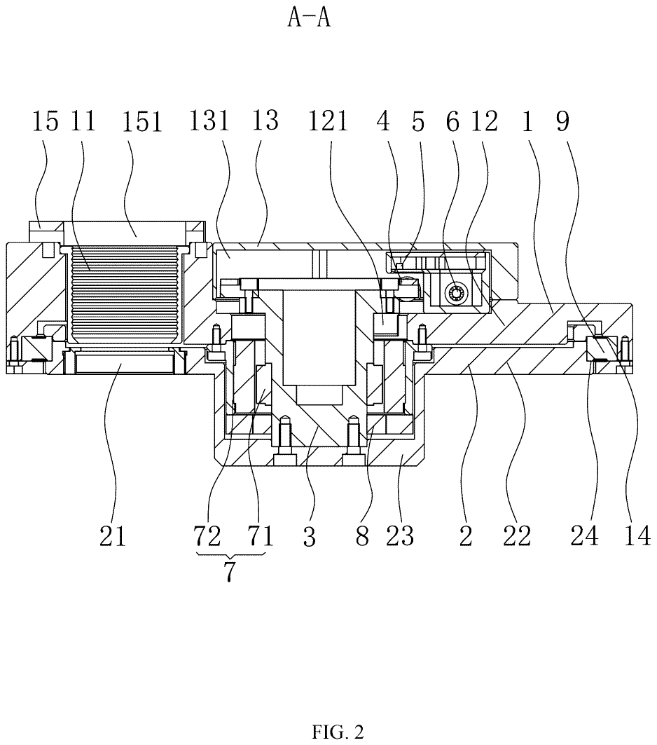

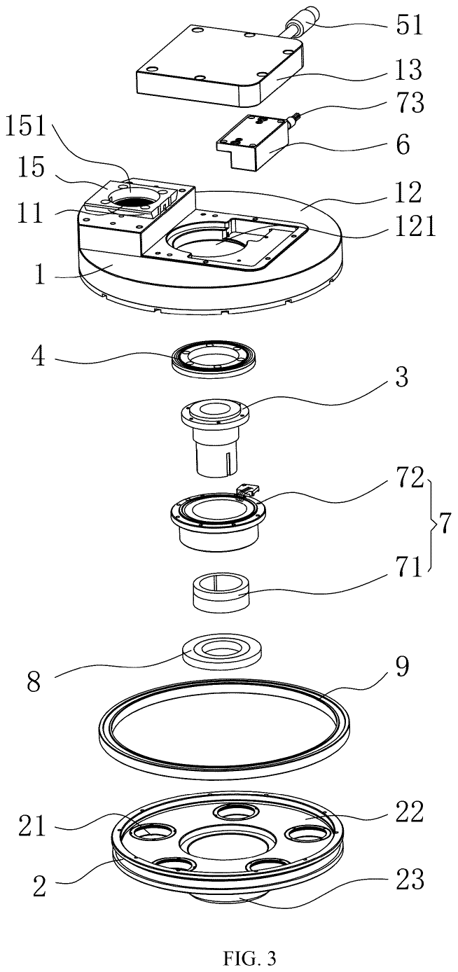

As shown in FIGS. 1 to 3, the first aspect of the present application provides a microscope objective turret, including a base 1 and a turntable 2 rotatably connected to the base 1. The base 1 is provided with a light-transmitting aperture 11, and the turntable 2 is provided with a plurality of objective mounting holes 21. The light-transmitting aperture 11 is aligned with any one of the objective mounting holes 21. The objective lens turret further includes a rotating connection member 3 fixedly connected to the turntable 2, a driving unit 7 coaxially arranged with the rotating connection member 3 and configured to drive the rotating connection member 3 to rotate, a grating scale 4 fixedly connected to the rotating connection member 3, a grating scale reader 5 fixedly connected to the base 1 and disposed on the outer periphery of the grating scale 4. The driving unit 7 drives the rotating connection member 3 to rotate and thereby drives the grating scale 4 to rotate. The grating scale reader 5 is configured to measure the rotational angle of the grating scale 4.

In an embodiment of the present application, the turntable 2 can rotate relative to the base 1, enabling the light-transmitting aperture 11 on the base 1 to align with any one of the objective mounting holes 21 on the turntable 2. Thus, when an objective lens is mounted in the objective mounting hole 21, a light path can be formed between the light-transmitting aperture 11 and the objective lens to achieve the magnification function of the objective lens. Additionally, multiple objective mounting holes 21 can accommodate different objective lenses, thereby meeting the requirements for different magnification effects. Furthermore, the driving unit 7 can drive the rotating connection member 3 to rotate, thereby driving the turntable 2 to rotate through the rotating connection member 3, achieving automation. Furthermore, the grating scale 4 is fixedly connected to the rotating connection member 3, so that the grating scale 4 and the turntable 2 can rotate synchronously by rotating the rotating connection member 3. A grating scale reader 5 is also fixedly connected to the base 1, Therefore, when the driving unit 7 drives the grating scale 4 and the turntable 2 to rotate synchronously through the rotating connector 3, the grating scale reader 5 can measure the rotational angle of the grating scale 4 and the turntable 2, thereby enabling positioning of the objective mounting hole 21 on the turntable 2, ultimately aligning the objective lens with the light-transmitting aperture 11. Compared to the mechanical positioning method in the related art, the embodiments of the present application can achieve full closed-loop feedback of the position and have higher positioning accuracy.

Additionally, the embodiment of the present application does not limit the fixing assembly method of the grating scale 4 and the rotating connection member 3. For example, the grating scale 4 and the rotating connection member 3 may be connected by screws, male-female connections, or welding.

The present application does not limit the fixing assembly method of the turntable 2 and the rotating connection member 3. For example, the turntable 2 and the rotating connection member 3 may be connected by screws, a male-female fit, or welding.

The present application does not limit the fixing assembly method of the grating scale reader 5 and the base 1. For example, the grating scale reader 5 and the base 1 may be connected via screws, male-female connections, or welding.

Furthermore, in some embodiments, the driving unit 7 includes a magnet 71 coaxially sleeved around the rotating connection member 3 and fixedly connected to the rotating connection member 3, and a coil 72 provided on an outer periphery of the magnet 71 and fixedly assembled to the base 1. The coil 72 is configured to drive the magnet 71 to rotate and thereby drive the rotating connection member 3 to rotate.

Specifically, the coil 72 can be energized to generate a magnetic field. being fixed in position, the coil 72 interacts with the magnet 71 to drive the magnet 71 to rotate, thereby driving the rotating connection member 3 to rotate, and further driving the turntable 2 and the grating scale 4 to rotate synchronously. This synchronized motion enables the grating scale reader 5 to measure the rotational angle, thereby positioning the objective mounting hole 21 on the turntable 2 and ultimately aligning the objective lens with the light-transmitting aperture 11. Additionally, by coaxially sleeving the magnet 71 around the rotating connection, the overall spatial structure is made more compact, reducing dimensions.

Further, in some embodiments, the base 1 includes a main body 12 connected to the turntable 2 and a cover portion 13 protruding from the main body 12 away from the turntable 2. The light-transmitting aperture 11 is arranged through the cover portion 13 and the main body 12. The main body 12 further includes a connection hole 121 arranged through the main body 12, and the cover portion 13 includes a connection cavity 131 that communicates with the connection hole 121. The connection hole 121 and the connection cavity 131 are both isolated from the light-transmitting aperture 11. At least a portion of the rotating connection member 3 passes through the connection hole 121 and extends into the connection cavity 131, and the grating scale 4 and grating scale reader 5 are located within the connection cavity 131.

Specifically, the main body 12 of the base 1 is connected to the turntable 2, and the main body 12 is provided with a through connection hole 121. The connection cavity 131 of the cover section 13 has an opening, and the connection cavity 131 is connected to the connection hole 121 through the opening. At least a portion of the rotating connection member 3 extends from the connection hole 121 into the connection cavity 131, thereby determining the position of the rotating connection member 3 within the base 1. The grating scale 4 and grating scale reader 5 are located within the connection cavity 131, thereby determining the position of the grating scale 4 and grating scale reader 5 within the base 1. Additionally, the grating scale reader 5 has a reader signal line 51 extending from it. Therefore, the cover section 13 may also be provided with a clearance hole communicating with the connection cavity 131, allowing the reader signal line 51 to be exposed externally through the clearance hole for connection to external components. Furthermore, the connection hole 121 and the connection cavity 131 are both arranged in isolation from the light-transmitting aperture 11, ensuring that the rotating connection member 3, the grating scale 4, and the grating scale reader 5 on the base 1 do not interfere with the light-transmitting aperture 11, allowing it to function normally.

Furthermore, in some embodiments, the turntable 2 includes a mounting portion 22 connected to the base 1 and a connection groove 23 extending from the mounting portion 22 away from the base 1. The connection groove 23 is in communication with the connection hole 121 and has an opening facing the connection hole 121. An end of the rotating connection member 3 close to the turntable 2 is fixed within the connection groove 23, and the plurality of objective mounting holes 21 are provided on the mounting portion 22 and arranged around the connection groove 23. The microscope objective turret further includes a damping device 8 located within the connection groove 23 and sleeved around the outer periphery of the rotating connection member 3.

Specifically, the mounting portion 22 of the turntable 2 may be connected to the base 1, and the connection groove 23 extending from the mounting portion 22 of the turntable 2 may be connected to the connection hole 121 through the opening, allowing the rotating connection member 3 to be partially located within the connection hole 121 and the connection cavity 131 while the remaining portion is located within the connection groove 23 and fixedly connected to it, thereby determining the position of the rotating connection member 3 relative to the turntable 2 and the base 1. Additionally, the damping device 8 is also located within the connection groove 23, thereby determining the position of the damping device 8 on the turntable 2. Furthermore, the side of the connection groove 23 on the turntable 2 that is opposite the connection hole 121 of the mounting portion 22 of the base 1 is a closed side, and the side of the connection cavity 131 of the cover portion 13 that is opposite the connection hole 121 of the mounting portion 22 is also a closed side. Thus, the connection groove 23, the connection hole 121, and the connection cavity 131 can collectively form a closed housing space, thereby accommodating the rotating connection member 3 and the damping device 8 within the closed housing space, and providing protective functionality for the rotating connection member 3 and the damping device 8.

Additionally, the objective mounting holes 21 are arranged around the connection groove 23, ensuring that the objective mounting holes 21 and the rotating connection member 3 do not interfere with each other. Furthermore, when the rotating connection member 3 drives the turntable 2 to rotate, the positions of the objective mounting holes 21 along the rotational direction can be adjusted, thereby enabling the replacement of objective lenses by rotating the turntable 2.

Furthermore, a damping device 8 is provided within the connection groove 23, mounted on the outer periphery of the rotating connection member 3. Thus, when the rotating connection member 3 drives the turntable 2 to rotate, the damping device 8 applies resistance to the rotational process, thereby suppressing vibration and positional fluctuations.

For example, the damping device 8 may be a friction-contact type rotational damper or a magnetic non-contact type rotational damper.

In some specific embodiments, the objective mounting hole 21 is provided on the mounting portion 22.

Furthermore, in some embodiments, the driving unit 7 is provided within the connection groove 23 and positioned between the grating scale 4 and the damping device 8.

Specifically, the driving unit 7 is coaxially arranged with the rotating connection member 3, and the driving unit 7 is disposed within the connection groove 23. Additionally, the driving unit 7 is located between the grating scale 4 and the damping device 8. This arrangement enables the relative positions of the base 1, the grating scale 4, the grating scale reader 5, the rotating connection member 3, the driving unit 7, the damping device 8, and the turntable 2, thereby accommodating the grating scale 4, the grating scale reader 5, the rotating connection member 3, the driving unit 7, and the damping device 8 within the enclosed accommodation space formed by the base 1 and the turntable 2. This results in a compact overall structure, improved space utilization, and reduced dimensions.

In some specific embodiments, the driving unit 7 includes a magnet 71 and a coil 72. The magnet 71 is coaxially sleeved around the outer surface of the rotating connector 3, and the coil 72 is disposed on the outer periphery of the magnet 71. Additionally, the magnet 71 and coil 72 are mounted within the connection groove 23 of the turntable 2. Additionally, the coil 72 and the base 1 may be fixedly connected by screw connections, male-female connections, or welding. Furthermore, the coil 72 has a power line 73 extending from it. The power line 73 may be led out to the connection cavity 131 of the cover section 13. Additionally, the cover section 13 may have an opening hole, allowing the power line 73 to ultimately protrude through the opening hole to the exterior for external electrical connection.

Further, in some embodiments, the outer peripheral side of the base 1 is provided with a first limiting groove 14 having an opening facing the turntable 2, and the outer peripheral side of the turntable 2 is provided with a second limiting groove 24 with an opening facing the base 1. The first limiting groove 14 and the second limiting groove 24 are arranged oppositely and spaced apart to form a limiting space, and the microscope objective turret further includes a support member 9 disposed in the limiting space.

Specifically, the support member 9 is a rigid structure. The first limiting groove 14 and the second limiting groove 24 may be configured in a “[” shape with opposing openings, thereby forming a limiting space between the two grooves. The two limiting grooves are spaced apart, such that the limiting space includes the internal space defined by the two limiting grooves and the space between the two limiting grooves. The support member 9 is located within the limiting space. With this configuration, when driving unit 7 drives the turntable 2 to rotate relative to the base 1, the support member 9 does not interfere with the relative rotation of the turntable 2 and the base 1, while also providing support force, enabling the turntable 2 and the base 1 to rotate relative to each other stably under the support of support member 9. Since the support member 9 is a rigid structure, compared to the structural configuration using inner ring bearings and outer ring bearings in the related art, the turntable 2 does not produce a radial deflection angle during rotation, strictly ensuring positional accuracy, enhancing structural rigidity, and improving structural load-bearing capacity.

Furthermore, in some embodiments, the microscope objective turret further includes a grating scale encoder 6 mounted within the connection cavity 131 and fixed to the base 1. The grating scale encoder 6 is configured to read the rotational angle data of the grating scale 4 and feed it back to an external controller.

Specifically, the grating scale 4 rotates synchronously with the turntable 2 through the rotating connection member 3. The grating scale encoder 6 reads the rotational angle data of the grating scale 4 and feeds it back to the external controller. The controller determines whether the turntable 2 has rotated to the desired position based on the difference between the actual data and the set data. i.e., whether the objective mounting hole 21 on the turntable 2 designated as the target object has reached the set position. If it has not reached the set position, the driving unit 7 continues to drive the rotation until the objective mounting hole 21 designated as the target object reaches the set position. Based on the positioning of the grating scale 4 and the grating scale reader 5, the microscope objective turret achieves enhanced precision positioning.

Furthermore, in some embodiments, the microscope objective turret further includes a protrusion 15 fixedly connected to a side of the base 1 away from the turntable 2. The protrusion 15 is provided with a mounting hole 151 in communication with the light-transmitting aperture 11, and the protrusion 15 is configured to connect to an external device.

Specifically, the protrusion 15 may be a dovetail groove, which may be configured to match the external device, enabling the entire device assembly to connect with external devices. Different external devices may be matched with different protrusions 15, thereby allowing the microscope objective turret to be compatible with various external devices, enhancing practicality.

Furthermore, in some specific embodiments, the light-transmitting aperture 11 is equipped with a light-transmitting sleeve for preventing stray light. The light-transmitting sleeve can prevent stray light in the optical path. Additionally, an end of the light-transmitting sleeve away from the turntable 2 is provided with the protrusion 15.

Furthermore, in some embodiments, the turntable 2 is provided with a plurality of adapter rings corresponding to the objective mounting holes 21. Different adapter rings are configured to match different objective lenses, thereby meeting the requirements for various magnification levels. When replacing an objective lens, the turntable 2 can be rotated to position the objective mounting hole 21 corresponding to the target objective lens at the desired location, aligning it with the light-transmitting aperture 11, after which the required adapter ring and objective lens can be installed.

The second aspect of the present application provides a microscope including a plurality of objective lenses and a microscope objective turret. The objective lenses are removably connected to the objective mounting hole 21.

In the present application, different objectives may be mounted on the same microscope objective turret to meet the needs of various magnification levels. Additionally, since the microscope objective turret is equipped with the grating scale 4 and the grating scale reader 5, when changing objectives, rotating the turntable 2 causes synchronous rotation of both the turntable 2 and the grating scale 4. The grating scale reader 5 can measure the rotational angle, enabling the objective mounting hole 21 on the turntable 2 to rotate to a predetermined position, thereby achieving high-precision positioning that meets practical requirements.

Described above are only embodiments of the present application, and it should be pointed out that, for the ordinary technical personnel in the field, improvements may also be made without departing from the premise of the concept of the present application, but these are all within the protection scope of the present application.

What is claimed is:

1. A microscope objective turret, comprising:
a base provided with a light-transmitting aperture;
a turntable rotatably connected to the base, and provided with a plurality of objective mounting holes, wherein the light-transmitting aperture is aligned with any one of the objective mounting holes;
a rotating connection member fixedly connected to the turntable;
a driving unit coaxially arranged with the rotating connection member and configured to drive the rotating connection member to rotate;
a grating scale fixedly connected to the rotating connection member; and
a grating scale reader fixedly connected to the base and disposed on an outer periphery of the grating scale;
wherein the driving unit drives the rotating connection member to rotate and thereby drives the grating scale to rotate, and the grating scale reader is configured to measure a rotational angle of the grating scale.

2. The microscope objective turret of claim 1, wherein the driving unit comprises a magnet coaxially sleeved around the rotating connection member and fixedly connected to the rotating connection member, and a coil provided on an outer periphery of the magnet and fixedly assembled to the base, wherein the coil is configured to drive the magnet to rotate and thereby drive the rotating connection member to rotate.

3. The microscope objective turret of claim 2, wherein the base comprises a main body connected to the turntable and a cover portion protruding from the main body away from the turntable; the light-transmitting aperture is arranged through the cover portion and the main body, and the main body further comprises a connection hole arranged through the main body; the cover portion further comprises a connection cavity communicating with the connection hole, wherein the connection hole and the connection cavity are both isolated from the light-transmitting aperture; at least a portion of the rotating connection member passes through the connection hole and extends into the connection cavity, and the grating scale and the grating scale reader are located within the connection cavity.

4. The microscope objective turret of claim 1, wherein an outer peripheral side of the base is provided with a first limiting groove with an opening facing the turntable, and an outer peripheral side of the turntable is provided with a second limiting groove with an opening facing the base; the first limiting groove and the second limiting groove are arranged oppositely and spaced apart to form a limiting space, and the microscope objective turret further comprises a support member disposed within the limiting space.

5. The microscope objective turret of claim 3, wherein the turntable comprises a mounting portion connected to the base and a connection groove extending from the mounting portion away from the base; the connection groove is in communication with the connection hole and has an opening facing the connection hole, an end of the rotating connection member close to the turntable is fixed within the connection groove, and the plurality of objective mounting holes are provided on the mounting portion and arranged around the connection groove; the microscope objective turret further comprises a damping device located in the connection groove and sleeved around an outer periphery of the rotating connection member.

6. The microscope objective turret of claim 5, wherein the driving unit is disposed within the connection groove and located between the grating scale and the damping device.

7. The microscope objective turret of claim 3, further comprising a grating scale encoder disposed within the connection cavity and fixed to the base, wherein the grating scale encoder is configured to read the rotational angle of the grating scale and feed it back to an external controller.

8. The microscope objective turret of claim 1, further comprising a protrusion fixedly connected to a side of the base back away from the turntable, wherein the protrusion is provided with a mounting hole communicating with the light-transmitting aperture, and the protrusion is configured to connect to an external device.

9. The microscope objective turret of claim 1, wherein the grating scale and the rotating connection member are connected by screws, male-female connections, or welding; and/or,
the turntable and the rotating connection member are connected by screws, male-female connections, or welding; and/or,
the grating scale reader and the base are connected by screws, male-female connections, or welding.

10. A microscope, comprising a plurality of objective lenses and the microscope objective turret of claim 1, wherein the plurality of objective lenses are removably connected to the plurality of objective mounting holes.
